(19) United States
(12) Patent Application Publication
(10) Pub. No.: US 2022/0146038 A1
(43) Pub. Date: May 12, 2022

(54) INSULATED PIPE COUPLING FOR A THREADED ROD

(71) Applicant: ZSI, INC., Canton, MI (US)

(72) Inventors: Robert DODGE, Birmingham, MI (US); Mark SCHWAGER, Washington Township, MI (US)

(73) Assignee: ZSI, INC., Canton, MI (US)

(21) Appl. No.: 17/438,425

(22) PCT Filed: Mar. 12, 2020
(86) PCT No.: PCT/US2020/022356

§ 371 Date: Sep. 11, 2021

Related U.S. Application Data
(60) Provisional application No. 62/817,399, filed on Mar. 12, 2019.

(51) Int. Cl. F16L 59/135

(52) U.S. Cl. CPC F16L 59/135

(57) ABSTRACT

A pipe insulation coupling supports a pipe and couples adjacent ends of pipe insulation tubing. The pipe insulation coupling comprises an elongated tube, an inner tube wall, an inner transverse wall, a first end wall, a second end wall, and a molded threaded insert. The elongated tube extends along a longitudinal axis between a first end and a second end. The inner tube wall is spaced inwardly from the elongated tube and extends along the longitudinal axis between the first end and the second end. The elongated tube and the inner tube wall are split longitudinally from the first end to the second end to define a first body portion and a second body portion. The inner transverse wall extends inwardly from the inner tube wall transverse to the longitudinal axis between the first and second ends. The inner transverse wall includes a center bore for receiving the pipe and provides an abutment for the adjacent ends of the insulation tubing. The first end wall extends between the inner tube wall and the elongated tube transverse to the longitudinal axis at the first end. The second end wall extends between the inner tube wall and the elongated tube transverse to the longitudinal axis at the second end. The molded threaded insert extends from the inner tube wail to the elongated tube transverse to the longitudinal axis between the first end and the second end.

### CROSS-REFERENCE TO RELATED APPLICATIONS

This application claims priority to U.S. provisional patent application no. 62/817,399, filed on Mar. 12, 2019, the disclosure of which is incorporated herein by reference.

### TECHNICAL FIELD

The present invention relates to a coupling for supporting an insulated pipe along a support structure. More specifically, the present invention relates to an insulated pipe coupling removably coupled to a threaded rod for supporting a pipe encased by insulation tubing wherein the threaded rod extends from the support structure.

### BACKGROUND OF THE INVENTION

Conventional pipes are used to convey or transfer fluids or gases in various industrial applications, such as sprinkler systems, refrigeration systems, and heating and cooling systems. These pipes are commonly encased in a cellular foam pipe insulation tubing, which maintains the fluids within the pipes at a desired temperature. The pipe insulation tubing is typically provided in predetermined lengths that are aligned end-to-end to cover an entire length of the pipe. It is desirable to interconnect adjacent ends of the pipe insulation tubing along the pipe to increase the insulation characteristics and efficiency of the pipe. The adjacent ends of the pipe insulation tubing are typically interconnected by tape, adhesive or straps. These means for interconnection are, however, susceptible to wear and tear over time. As an alternative, various pipe insulation coupling members have been introduced to provide a secure and long-lasting end-to-end attachment of adjacent pipe insulation tubing lengths along the pipe. An example of one type of pipe insulation coupling is disclosed in U.S. Pat. No. 6,315,006 to Opperthauser.

In a typical application, the insulated pipe, that is, the pipe encased by the pipe insulation tubing, is disposed along a support structure, such as a ceiling or wall. The Insulated pipe is commonly supported along the ceiling by a plurality of spaced apart clevis hangers. Each clevis hanger typically includes an upper member mounted to the ceiling, and a generally U-shaped lower member for supporting the insulated pipe. The shape of the U-shaped lower member complements that of an outer periphery of an insulated pipe, thereby allowing the U-shaped lower member to retain the insulated pipe therein. An example of this type of clevis hanger is disclosed in U.S. Pat. No. 5,219,427 to Harris.

Many prior art clevis hangers, support devices, and pipe mounting clamps disadvantageously comprise a number of components which must be manipulated and assembled in place. This is made particularly difficult by the fact that often times this must be done while an installer is standing on a ladder holding the insulated pipe to be supported. In addition, these types of clevis hangers, support devices, and clamps are labor intensive, costly and inefficient.

U.S. Pat. No. 7,207,527 to Opperthauser discloses a pipe support assembly for securing a pipe and adjacent ends of pipe insulation tubing surrounding the pipe to a support structure. The pipe support assembly includes a clevis hanger assembly that includes coupling slots for receiving and retaining a pipe insulation coupling therein, whereby the pipe insulation coupling maintains adjacent ends of the pipe insulation tubing in an end-to-end relationship along the pipe.

It remains desirable, however, to provide a pipe insulation coupling having an integrated mounting clamp to allow for easily securing the coupling to a flat surface, such as a ceiling or wall.

### SUMMARY OF THE INVENTION

According to one embodiment, there is provided a pipe insulation coupling for supporting a pipe and for coupling adjacent ends of pipe insulation tubing. The pipe insulation coupling comprises an elongated tube, an inner tube wall, an inner transverse wall, a first end wall, a second end wall, and a molded threaded Insert. The elongated tube extends along a longitudinal axis between a first end and a second end. The inner tube wall is spaced Inwardly from the elongated tube and extends along the longitudinal axis between the first end and the second end. The elongated tube and the inner tube wall are split longitudinally from the first end to the second end to define a first body portion and a second body portion. The inner transverse wall extends inwardly from the inner tube wall transverse to the longitudinal axis between the first and second ends. The inner transverse wall includes a center bore for receiving the pipe and provides an abutment for the adjacent ends of the insulation tubing. The first end wall extends between the inner tube wall and the elongated tube transverse to the longitudinal axis at the first end. The second end wall extends between the inner tube wall and the elongated tube transverse to the longitudinal axis at the second end. The molded threaded insert extends from the inner tube wall to the elongated tube transverse to the longitudinal axis between the first end and the second end.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a pipe insulation coupling in accordance with one embodiment of the present invention;

FIG. 2 Is a top view of the pipe insulation coupling of FIG. 1;

FIG. 3 is a cross-sectional view of the pipe insulation coupling taken along line A-A of FIG. 2;

FIG. 4 is a side elevation view of the pipe insulation coupling of FIG. 1;

FIG. 5 is an end view of the pipe insulation coupling of FIG. 1; and

FIG. 6 is a perspective view of the pipe insulation coupling of FIG. 1 affixed to an elongated pipe with insulation tubing surrounding the pipe on one side of the pipe Insulation coupling.

### DETAILED DESCRIPTION OF EXAMPLE EMBODIMENTS

Directional references employed or shown in the description, figures or claims, such as top, bottom, upper, lower, upward, downward, lengthwise, widthwise, left, right, and the like, are relative terms employed for ease of description and are not Intended to limit the scope of the invention in any respect. For example, the figures illustrate a pipe insulation coupling that may be mounted onto a ceiling or any flat surface. It will be readily apparent that the pipe insulation coupling according to the present disclosure may be mounted in any direction.

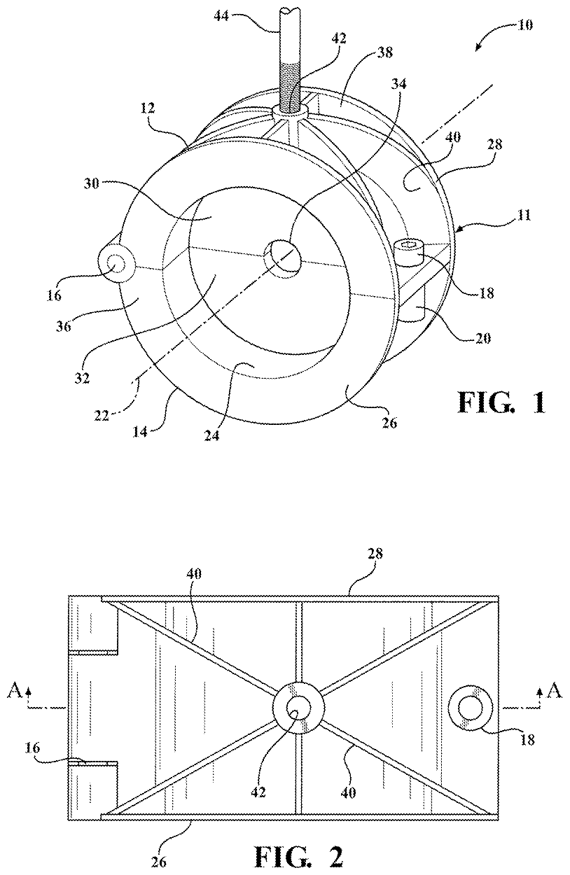

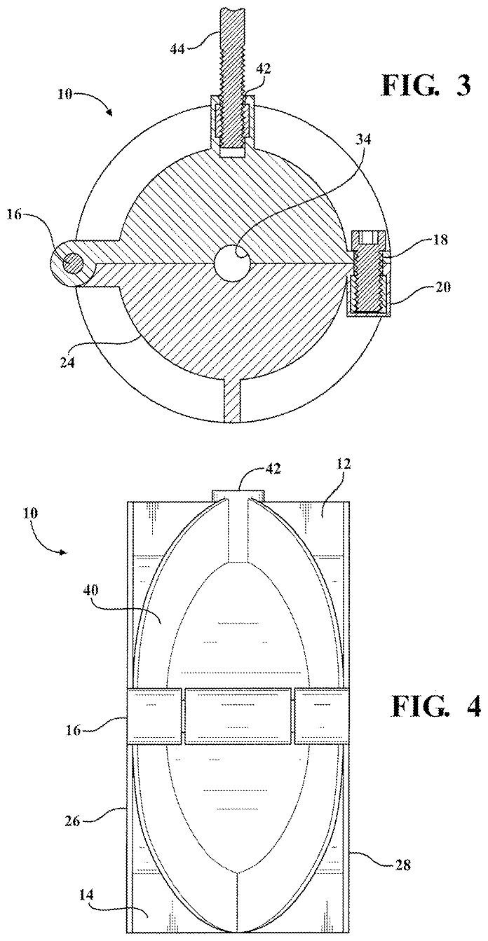

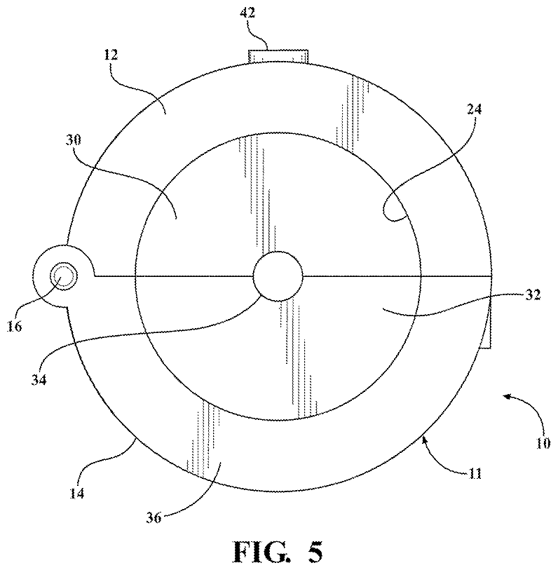

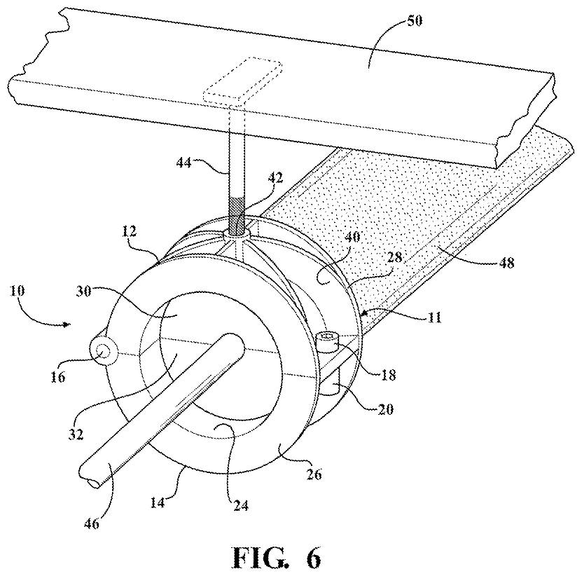

FIGS. 1-6 illustrate one embodiment of an insulated pipe coupling 10. The insulated pipe coupling 10 is preferably formed from molded plastic. The insulated pipe coupling 10 includes an elongated tube 11 defined by the outer periphery of the insulated pipe coupling 10. The elongated tube 11 extends along a longitudinal axis 22 between longitudinally spaced apart first and second ends 26, 28. Although depicted as cylindrically shaped, the elongated tube 11 may be molded into any shape without varying from the scope of the invention. The insulated pipe coupling 10 also includes an inner tube wall 24 extending along the longitudinal axis 22 between the first and second ends 26, 28. The inner tube wall 24 is spaced inwardly from the elongated tube 11.

A transverse center wall 30, 32 extends inwardly from the inner tube wall 24 transverse to the longitudinal axis 24 between the first and second ends 26, 28. The transverse center wall 30, 32 divides the tube 11 in longitudinal halves and forms a center opening 34 for receiving a pipe 46 therethrough. The inner tube wall 24 receives and supports insulation tubing 48 surrounding the pipe 46, and the transverse center wall 30, 32 provides an abutment for adjacent ends of the insulation tubing 48.

The tube 11 is formed by having a first clam shell portion 12 pivotally coupled to a second clam shell portion 14 by a hinge pin 16. Alternatively, the first clam shell portion 12 may be pivotally coupled to the second clam shell portion 14 by a living hinge. The clam shell portions 12, 14 are pivotal about the pin 16 between an open position for receiving the elongated insulated pipe 46, 48 therebetween and a closed position closed about the perimeter of the insulated pipe 46, 48. The clam shell portions 12, 14 may be held in the closed position by a fastening screw 18 extending into a molded threaded insert 20 in one of the portions 12, 14 to lock the coupling 10 about the pipe 46. Alternatively, it should be appreciated that the clam shell portions 12, 14 may be held in the closed position by a clip or latch integrally molded into the portions 12, 14 without varying from the scope of the invention.

The insulated pipe coupling 10 includes a first end wall 36 extending between the inner tube wall 24 and the elongated tube 11 at the first end 26, and a second end wall 38 extending between the inner tube wall 24 and the elongated tube 11 at the second end 28. The first and second end walls 36, 38 are transverse to the longitudinal axis 22. A plurality of structural reinforcement ribs 40 project from the inner tube wall 24 to the elongated tube 11. between the first and second ends 26, 28 for providing structural strength and rigidity to the coupling 10. Finally, a molded threaded insert 42 extends from the inner tube wall 24 to the elongated tube 11 transverse to the longitudinal axis 22 between the first and second ends 26, 28. The molded threaded insert 42 is seated in one of the clam shell portions 12, 14 for receiving the distal end of a threaded rod 44 extending from a support structure, such as a ceiling 50, to secure and support the coupling 10 and insulated pipe 46, 48.

The present invention entirely eliminates the need for clevis hangers to support the insulated pipe 46, 48 along a support structure by integrating the function of the clevis hanger directly Into the insulated pipe coupling 10. The present Invention, therefore, can significantly reduce the cost of assembling and mounting the insulated pipe 46, 48 by not only eliminating the need for a clevis hanger, which can add significant cost to a project, but also by simplifying the assembly process and reducing assembly time. By molding a molded threaded insert 42 into the insulated pipe coupling 10, a threaded rod 44 may be used to mount the coupling 10 directly to the ceiling 50 or another flat surface.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. A pipe insulation coupling for supporting a pipe and for coupling adjacent ends of pipe insulation tubing, the pipe insulation coupling comprising:
an elongated tube extending along a longitudinal axis between a first end and a second end;
an inner tube wall spaced inwardly from the elongated tube and extending along the longitudinal axis between the first end and the second end, wherein the elongated tube and the inner tube wall are split longitudinally from the first end to the second end to define a first body portion and a second body portion;
an inner transverse wall extending inwardly from the inner tube wall transverse to the longitudinal axis between the first and second ends, wherein the inner transverse wall includes a center bore for receiving the pipe and the inner transverse wall provides an abutment for the adjacent ends of the insulation tubing;
a first end wall extending between the inner tube wall and the elongated tube transverse to the longitudinal axis at the first end;
a second end wall extending between the inner tube wall and the elongated tube transverse to the longitudinal axis at the second end; and
a molded threaded insert extending from the inner tube wall to the elongated tube transverse to the longitudinal axis between the first end and the second end.

2. The pipe insulation coupling of claim 1 further comprising a plurality of structural reinforcement ribs projecting from the inner tube wall to the elongated tube between the first and second ends.

3. The pipe Insulation coupling of claim 2 further comprising a hinge pivotally coupling the first body portion to the second body portion.

4. The pipe insulation coupling of claim 3 further comprising a sealing mechanism for securing the first and second body portions together.

5. The pipe insulation coupling of claim 4 wherein the sealing mechanism comprises a molded threaded insert in the first or second body portion and a fastening screw.
